(19) United States
(12) Patent Application Publication
(10) Pub. No.: US 2016/0110787 A1
(43) Pub. Date: Apr. 21, 2016

(54) SYSTEM AND METHOD FOR RESELLING JEWELRY AND WATCHES

(71) Applicant: GEMECT INC., LONG ISLAND CITY, NY (US)

(72) Inventors: Anny Bibian, Long Island City, NY (US); Shawn Bibian, Long Island City, NY (US)

(21) Appl. No.: 14/728,894

(22) Filed: Jun. 2, 2015

Related U.S. Application Data
(60) Provisional application No. 61/974,706, filed on Apr. 3, 2014.

(51) Int. Cl. G06Q 30/06

(52) U.S. Cl. CPC G06Q 30/0609; G06Q 30/0641

(57) ABSTRACT

A resale management system useful in reselling jewelry items that includes a computer server capable of being coupled to one or more seller computers and one or more jeweler computers. The computer server can be programmed to: receive a listing from a seller computer, the listing can include a description of a jewelry item, and the seller computer can be associated with a specific geographic location; match a jeweler contained in an entity database to the specific geographic location; send a first notification to a seller computer and a second notification to a jeweler computer defining a period of time for allowing the jeweler to verify the jewelry item; receive a verification signal from the jeweler via the jeweler computer that the description of a jewelry item depicts the jewelry item; and offer the listing for sale on an on-line store associated with the computer server.

### CROSS REFERENCE TO RELATED APPLICATIONS

This application claims priority to U.S. Provisional Pat. App. Ser. No. 61/974,706 filed on Apr. 3, 2014, which is incorporated by reference in its entirety.

### BACKGROUND

The subject matter described herein relates to system and method for reselling jewelry and watches.

Most people throughout their lives acquire jewelry pieces, e.g., necklaces, bracelets, rings, watches, etc. These jewelry pieces are sometimes worn for a short period of time, if at all, and are put away in a jewelry box of some sort. The owner may no longer want the item but most people are afraid to sell their jewelry. This fear sterns from the thought that (1) if sold online, the buyer may pay for the item and later dispute it, or use a fraudulent account for payment (2) if sold to a local jeweler or pawn shop, the price they may be paid will be far below the fair market value, (3) a precious stone can be switched with a lower value stone by seller, a non-authorized appraisal location, family members or buyer (4) if shipped, the item may be lost in the mail and (5) many other disastrous scenarios. These scenarios prevent jewelry owners from selling to other consumers and getting the price that is fair. On the buyer's side, the buyers are also afraid to buy online, fearing that something fake, damaged, of lower value or not as described will be shipped to them.

### SUMMARY

The disclosed technology relates to a system and method for reselling jewelry and watches. For example, a seller can list an item for sale on the internet and drop the item off to a local jewelry store without having to ship the item in the mail. The jewelry store would verify that the item is as described in the online sales page and the jeweler ships the item to the buyer when it is sold. The seller would be paid in a secure transaction and the buyer would receive the item as described and guaranteed by the jewelry store.

In one implementation, a resale management system useful in reselling jewelry items can comprise: a computer server, which computer server is capable of being coupled to at least one seller computer and at least one jeweler computer and programmed to: (i) receive a listing from the at least one seller computer, the listing including a description of a jewelry item, and the at least one seller computer being associated with a specific geographic location; (ii) match at least one jeweler contained in an entity database to the specific geographic location, the entity database containing information on a plurality of jewelers; (iii) send a first notification to the at least one seller computer and a second notification to the at least one jeweler computer defining a period of time for allowing the at least one jeweler to verify the jewelry item; (iv) receive a verification signal from the at least one jeweler via the at least one jeweler computer verifying that the description of the jewelry item depicts the jewelry item; and (v) offer the listing for sale on an on-line store associated with the computer server.

In some implementations, the computer server can be further programmed to: receive seller information; and store the seller information in the entity database.

In some implementations, the computer server can further programmed to: receive jeweler information from the plurality of jewelers; and store the jeweler information in the entity database.

In some implementations, the listing from the at least one seller computer can include an asking price and the verification signal can further verifies that the asking price is fair and reasonable.

In some implementations, wherein the jewelry items can includes rings, bracelets, necklaces, watches, earring, loose stones or any other item that may adore a user.

In some implementations, the listing can be stored in a jewelry database under a listing number generated by the resale management system.

In some implementations, the specific geographic location can be one of zip code, physical address, or GPS coordinates. In some implementations, the computer server can be further programmed to: compare the specific geographic location to a location of the plurality of jewelers; generate a listing of jewelers that are in close proximity to the specific geographic location; and receive a request from the at least one seller computer choosing a specific jeweler from the list of jewelers.

In some implementations, the first notification can further include a listing number, the at least one jeweler's address, name of contact and phone number and a period of time to get the jewelry item to the at least one jeweler.

In some implementations, the second notification can include a listing number, listing details, seller's name and phone number, and a printer ready label containing the listing number and a brief description of the item.

In some implementations, the computer server can be further programmed to: receive buyer information; and store the buyer information in the entity database.

In some implementations, the computer server can be further programmed to: allow a buyer to browse for desired jewelry item. In some implementations, the computer server can be further programmed to: allow a buyer to purchase the jewelry item in the on-line store. In some implementations, the computer server can be further programmed to: distribute payment to a seller with the jeweler receiving a first percentage and an entity associated with the resale management system receiving a second percentage.

In another implementation, a computer-implemented method comprises the steps of: receiving a listing from the at least one seller computer, the listing including a description of a jewelry item, and the at least one seller computer being associated with a specific geographic location; matching at least one jeweler contained in an entity database to the specific geographic location, the entity database containing information on a plurality of jewelers; sending a first notification to the at least one seller computer and a second notification to the at least one jeweler computer defining a period of time for allowing the at least one jeweler to verify the jewelry item; receiving a verification signal from the at least one jeweler via the at least one jeweler computer verifying that the description of the jewelry item depicts the jewelry item; and offering the listing for sale on an on-line store associated with the computer server.

In some implementations, the listing can be stored in a jewelry database under a listing number generated by the resale management system.

In some implementations, the method can further comprise the steps of: comparing the specific geographic location to a location of the plurality of jewelers; generating a listing of jewelers that are in close proximity to the specific geographic location; and receiving a request from the at least one seller computer choosing a specific jeweler from the list of jewelers.

In some implementations, the first notification can further include a listing number, the at least one jeweler's address, name of contact and phone number and a period of time to get the jewelry item to the selected jeweler. In some implementations, the second notification can include a listing number, listing details, seller's name and phone number, and a printer ready label containing the listing number and a brief description of the item.

### BRIEF DESCRIPTION OF THE DRAWINGS

FIGS. 1a-c show a flow chart illustrating an example of the disclosed technology;

FIG. 2 shows a flow chart illustrating an example of the disclosed technology;

FIG. 3 shows a flow chart illustrating an example of the disclosed technology; and

FIG. 4 shows a schematic diagram of an example of the disclosed technology.

### DETAILED DESCRIPTION

In the jewelry resale industry, it is well known that most pawn shops and jewelry stores usually don't give fair prices to those trying to sell their items. It is also well known that internet sales are risky, e.g., a buyer may not pay for an item or disputes may arise that claims the buyer received something different from what was advertised.

Sometimes an escrow can be created for a resale of a jewelry item but escrow just guarantees that you will receive something, not the specified item. So if the buyer receives a ring, it may not necessarily be exactly what was advertised and there is no way to know if the buyer received the wrong item or if they just claim that the item is not as described. Once the buyer has the item, the seller doesn't know if the claim is true or if the buyer has switched out the center stone of a diamond ring for example and is now claiming that it is not as described.

Using a middleman doesn't guarantee a good sale either. The middleman would have to be a jewelry appraiser for it to work. However in that case, many sellers cannot sell on the internet to others across the country with the middleman being local, or without having to ship to a middleman.

If shipping to a middleman, there are also many risks. A package may be lost in shipment and UPS and FedEx do not insure jewelry over $500. Even if a shipping company allows you to ship with a larger insurance purchase, they have a disclaimer which states it is not applicable to jewelry. Many people are afraid to ship and have their precious jewels in the hands of a middleman company for long periods of time.

There is no service where one can take an item to a trusted local jeweler and at the same time be able to sell the item to consumers on the internet all over the country. Same for the buyer, there is no way to buy from another person but receive the item from a retailer who guarantees it.

This disclosed technology solves both seller and buyer issues while allowing local jewelry stores to receive a percentage of sales, In one implementation, the above problems can be solved by the seller being able to list an item for sale on the internet, yet drop it off to a local jewelry store, without having to ship in the mail. The jewelry store would verify that the item is as described in the online sales page and the jeweler ships the item to the buyer when it is sold. The seller would be paid by the jeweler or the site and the buyer would receive the item as described and guaranteed by the jewelry store. The buyer is insured a guaranteed item while the seller is insured guaranteed payment.

By being able to sell to other people online, with a drop off service to local jewelers, sellers are guaranteed their money when item is sold, while buyers are guaranteed their item to be as described. Buyers don't have to worry about sellers not sending the item or sending a different item and sellers need not worry about returns or nonpayment.

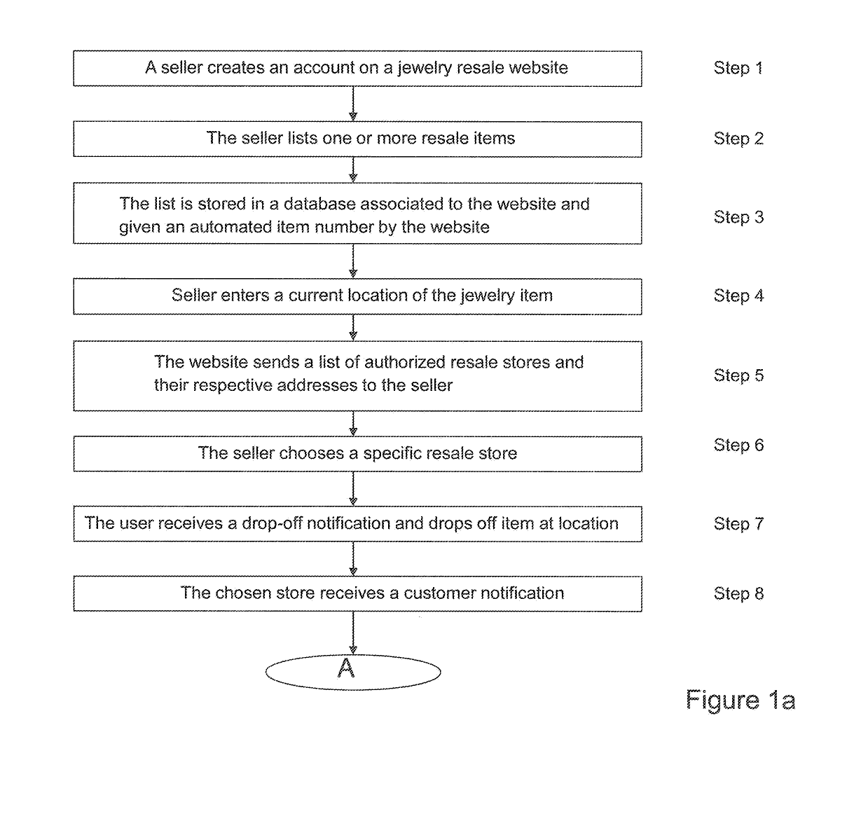

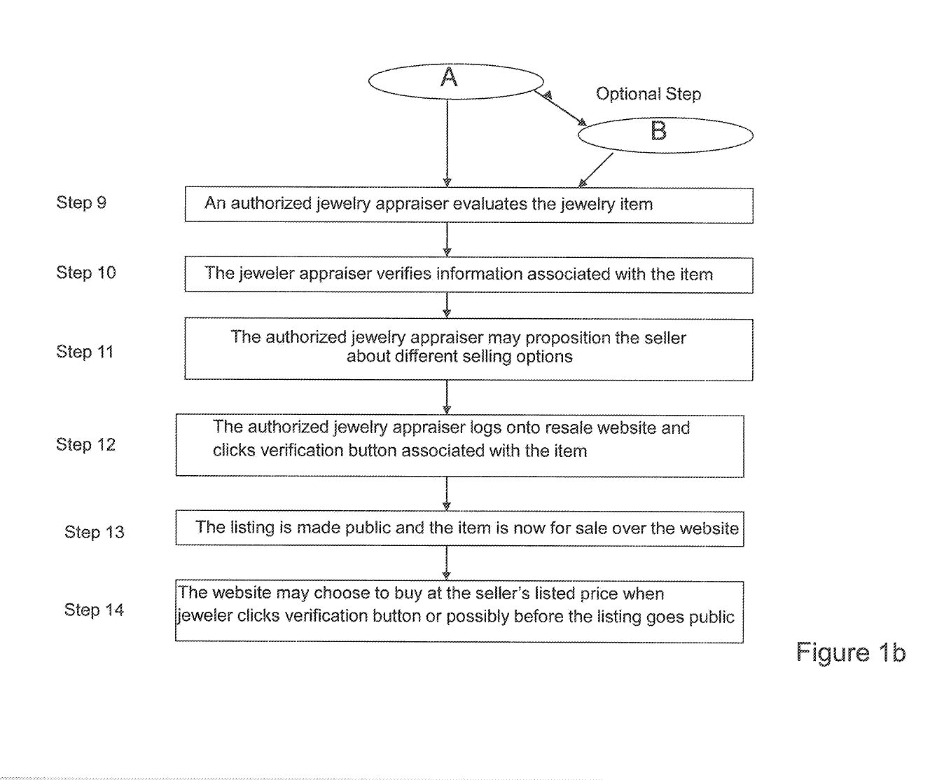

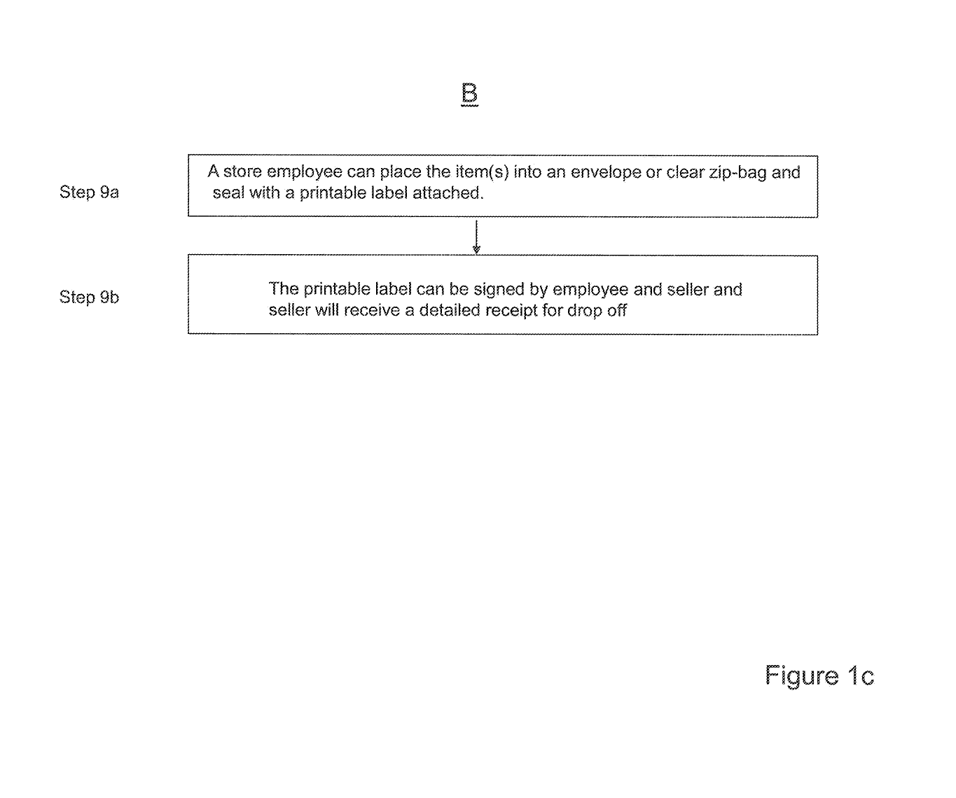

in a one implementation, as shown in FIGS. 1a-c, a seller may create an account or register on a jewelry resale website through a secure network. (Step 1). The account information can include seller's name, address, e-mail address, and any other pertinent information. After the seller account is verified, the seller can list one or more resale items. (Step 2). The list is not published at this time but can be stored in a database associated to the website and given an automated item number by the website. (Step 3). Seller also has the option to make a full listing or just start the process by entering basic information on the jewelry to be resold and choosing to complete at a later time or choosing for jeweler to complete listing, as will be described more fully below.

Seller enters a current location of the jewelry item, e.g., a zip code or address of the seller, or the place where the jewelry is stored. (Step 4). In return, the website provides a list of authorized resale stores and their respective addresses to the seller. (Step 5). The seller chooses a specific resale store and receives store name, address, phone number, hours of operation and contact information. (Step 6). The user is then given a notification that includes a period of time to drop off the sale item, e.g., seller has 2 days to drop off item at chosen location via an e-mail notification or some other type of notification, e.g. text message. (Step 7). Seller can make an appointment with desired drop off store or walk-in to chosen store for jewelry evaluation.

The chosen store also receives a notification of sellers contact information, listing number and other pertinent information. In the notification, the chosen store can receive a printable label that includes identifying information, such as, seller's name, listing number, item to be sold and seller's asking price and the period of time seller was given to drop off the sale item. (Step 8). In some implementations, a label can be filled out by hand by the seller or the jeweler.

Once seller with jewelry item to be sold enters the chosen store, an authorized jewelry evaluates the jewelry item for verification. (Step 9). 1

In some implementations, the authorized jewelry can also perform an appraisal. This appraisal may or may not take place in front of seller. If not in front of seller, at drop-off, a store employee can place the item(s) into an envelope or clear zip-bag and seal with the printable label attached. (Step 9a). The printable label can be signed by employee and seller will receive a detailed receipt for drop off. (Step 9b).

During the verification, the authorized jewelry appraiser checks the item to verify color, clarity, carat and all other descriptions match the item listed for sale. If there is a certificate, the jeweler verifies the information on the certificate/appraisal. (Step 10). in some implementations, if the asking price set by the seller is too high or if the seller did not list an asking price, the authorized jewelry appraiser can suggest an asking price and the seller can decide to edit the asking price at that time.

In some implementations, the authorized jewelry appraiser may proposition the seller and (1) instantly buy the item at the seller's listed price, or (2) ask to display the item for sale in the store on consignment at seller's price, or (3) ask to display the item for sale in the store on consignment at seller's price and also offer it for sale online simultaneously. (Step 11). The authorized jewelry appraiser logs onto resale website and clicks verification button associated with the item. If the listing was not completed by the seller and was chosen to complete by jeweler the listing is completed by jeweler at this time. (Step 12). The listed item is now verified and guaranteed to be as described. At this time, the listing is made public and the item is now for sale over the website. (Step 13). In some implementations, the website may choose to buy at the seller's listed price when jeweler clicks verification button or possibly before the listing goes public. (Step 14).

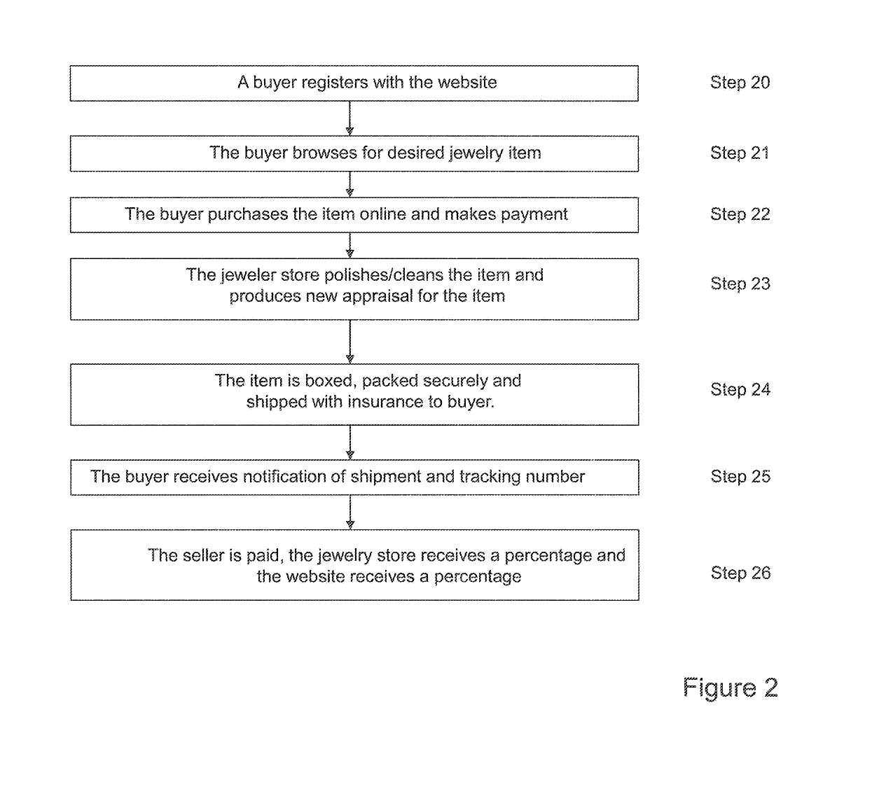

On the buyer's side, as shown in FIG. 2, a buyer registers with the website. (Step 20). In some implementations, the buyer can browse without registering and register with the website when making a purchase. The buyer browses for desired jewelry/watch. (Step 21). The buyer purchases the item online and makes payment. (Step 22). In some implementations, the buyer can make a counter-offer for the jewelry item that is below asking price. The counter-offer can be sent to the buyer for approval, the counter-offer can be denied or the seller can offer a price between the asking price and the counter-offer.

After payment is verified, the jeweler store polishes/cleans the item and produces a new appraisal for the item. (Step 23). The item is boxed, packed securely and shipped with insurance to buyer. (Step 24). The buyer receives notification of shipment and tracking number. (Step 25). The seller is paid, the jeweler receives a percentage and the website receives a percentage. (Step 26). In other implementations, the buyer has the option to have the item shipped to himself/herself, have the item shipped to another authorized store where he/she can pick up, or if the original location is local then have the option if picking up from that store as well and combinations of the above.

Most steps may be interchanged with the same results.

For example, Step 1 is necessary in order to create a listing on the site, but this step can be moved further down while still getting the same service. For example, if a person is familiar with a participating local jewelry store he/she may skip all or many of steps and just walk into a participating local jewelry store where all information can be entered by the jewelry store. While doing it this way is not conventional, it is very possible. So if this seller takes a ring and the jeweler evaluates the ring on the spot, notifies seller that it matches the description/certificate or appraisal the seller can leave the ring with the store, skipping all the steps in the beginning. The seller must create an account at some point if he/she wants to personally list the item. However, if he/she opts for the store to list it, an account can be created by the store for the seller.

The store may sell it for the seller and pay them in form of a check without the seller ever making an account or going through the conventional steps. Instead of the jeweler logging on to click verification button. The jeweler may also call the website and verify the item to be guaranteed. The website would then make the item guaranteed and listing live.

if the jeweler discovers that the item does not match the description, the seller must be notified. The seller may choose to then make the necessary changes to the listing so that the new color/clarity weight and other specifications match the listing. The jeweler would then automatically verify the listing once the changes have been made because the item has already been inspected.

Once the item is inspected, the jeweler may choose to produce a new appraisal, polish the item box and prepare it for shipment once it sells and payment is received.

If another participating jewelry store on the site, is interested in the listing that store may choose to instantly purchase the item after the original store and the website pass on instant buy. if a different store purchases the item, some steps can also be omitted and the buyer paid. The jeweler would just ship the ring without polishing or appraisal to the purchasing store.

For example, Seller Jenny wants to sell her engagement ring in a secure transaction. Jenny decides her best option is to offer it on sale on the internet using a resale management system of the disclosed technology. To begin the process, Jenny registers with the resale management system and creates a listing. The listing can include a description of the engagement ring, an asking price, a picture of the engagement ring and/or any certifications that authenticate the engagement ring.

Once the listing is created on the resale management server, the listing can be stored in a jewelry database and stored under a listing number generated by the resale management system. In some implementations, the listing number can be generated when Jenny is done with her input, before or at the time that she chooses a jeweler, described below, or possibly generated when she hits a “save for later” button. Please note that at any point before a jeweler verifies the jewelry item, as described below, Jenny can edit and/or update the listing by accessing the system and entering user ID and her listing number.

After the listing is created, Jenny can enter her geographic location, e.g., zip code, physical address, or GPS coordinates. The resale management system can then compare her geographic location to a listing of jewelers stored in a jeweler database. The system can then generate a listing of jewelers that are in close proximity to Jenny's location.

Jenny can then choose a jeweler from the list. Once selected, Jenny receives a notification, e.g., an email or text, notifying her of the listing number, the selected jeweler's address, name of contact and phone number and a period of time she has, e.g., one to seven days, to get her ring to the selected jeweler. At this same time, the selected receives a notification , e.g., an e-mail/text. The jeweler notification can include the listing number, the listing details, Jenny's info, e.g., name and phone number, and a printer ready label contains at least the listing number, brief description of the item and the period of time given to the seller to drop off the sale item.

Jenny, within the specified period of time, physically enters the jewelry store location and asks for the contact person received in her notification. Jenny will then relinquish the ring to the contact person and the contact person will bag and mark the item with printer ready label.

The contact person or an on-site jewelry appraiser evaluates the ring and notifies Jenny if the ring matches her description. If the ring matches the description, Jenny and contact person agree to the match and Jenny receives a receipt to that effect. If there are mistakes in the listing or the listing is not accurate, the contact person can edit the listing before accepting the listing to go live on the website.

Contact person logs onto the resale management system and enters Jenny's listing number. Contact person accesses the listing and completes the listing by entering pertinent information Jenny may have left out, e.g., gold purity, weight etc. In some implementations, Jenny can let the contact person set the asking price for the jewelry item and edit the listing to include the asking price. This editing step may be completed in front of Jenny or after she has left the store. Once the listing is complete, the contact person transmits a VERIFY/GUARANTEE signal to the resale management system, e.g., by hitting a verify/guarantee button on the screen or some other method of verification notification. Once verified, the contact person and Jenny no longer having editing access to the listing and the listing goes on-sale and becomes part of a searchable on-sale listing. In some implementations, if the jeweler wants to purchase jenny's ring, there can be an option, e.g., “Purchase Myself” button that the jeweler would click.

Buyer Bob who is in search for an engagement ring can register with the resale management system and search the jewelry database for desired items. If Bob decides to buy Jenny's ring, Bob can click a BUY button, or use some other method to signify a sale, and enter his payment information, e.g., credit card number. In some implementations. Bob can search the database prior to registering with the system and register with the system at point of purchase. Once Bob has purchased/paid, the jeweler will receive a notification of the sale. The notification can include Bob's name and mailing address and the listing number. Jeweler then prepares the ring for shipment and ships the ring. After shipping, the jeweler can log into the resale management system and click “SHIPPED” and enters the shipment information and tracking number.

Bob then receives a notification of the shipping information and a receipt for the transaction. Once Bob's payment clears and the ring is shipped, the resale management system can make payments to Jenny and the jeweler for the sale of the ring.

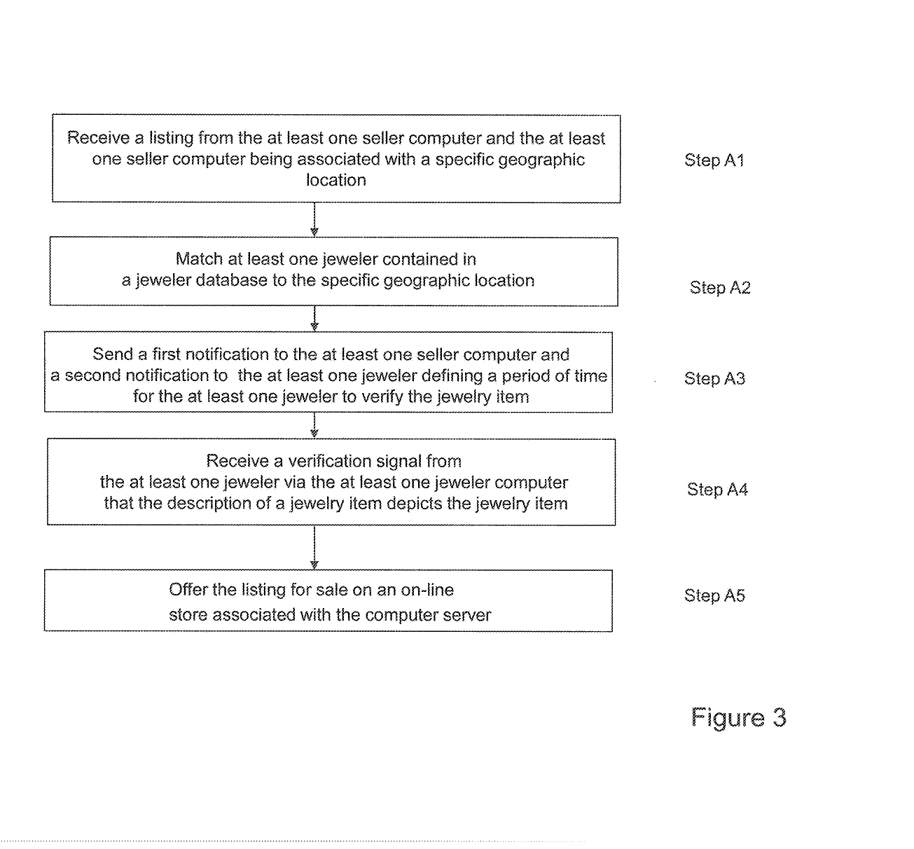

In another implementation, as shown in FIG. 3 is a resale management system useful in reselling jewelry items. The system can comprise a computer server that is capable of being coupled to at least one seller computer and at least one jeweler computer and programmed to receive a listing from the at least one seller computer. (Step A1). The listing can contain a description of a jewelry item. The at least one seller computer can also be associated with a specific geographic location. Once a listing is received, the computer server can also match at least one jeweler contained in a jeweler database to the specific geographic location. (Step A2). The computer server can then send a first notification to the at least one seller computer and a second notification to the at least one jeweler computer defining a period of time for allowing the at least one jeweler to verify the jewelry item. (Step A3), The computer server can also receive a verification signal from the at least one jeweler via the at least one jeweler computer that the description of a jewelry item depicts the jewelry item. (Step A4). The computer server can also offer the listing for sale on an on-line store associated with the computer server. (Step AS).

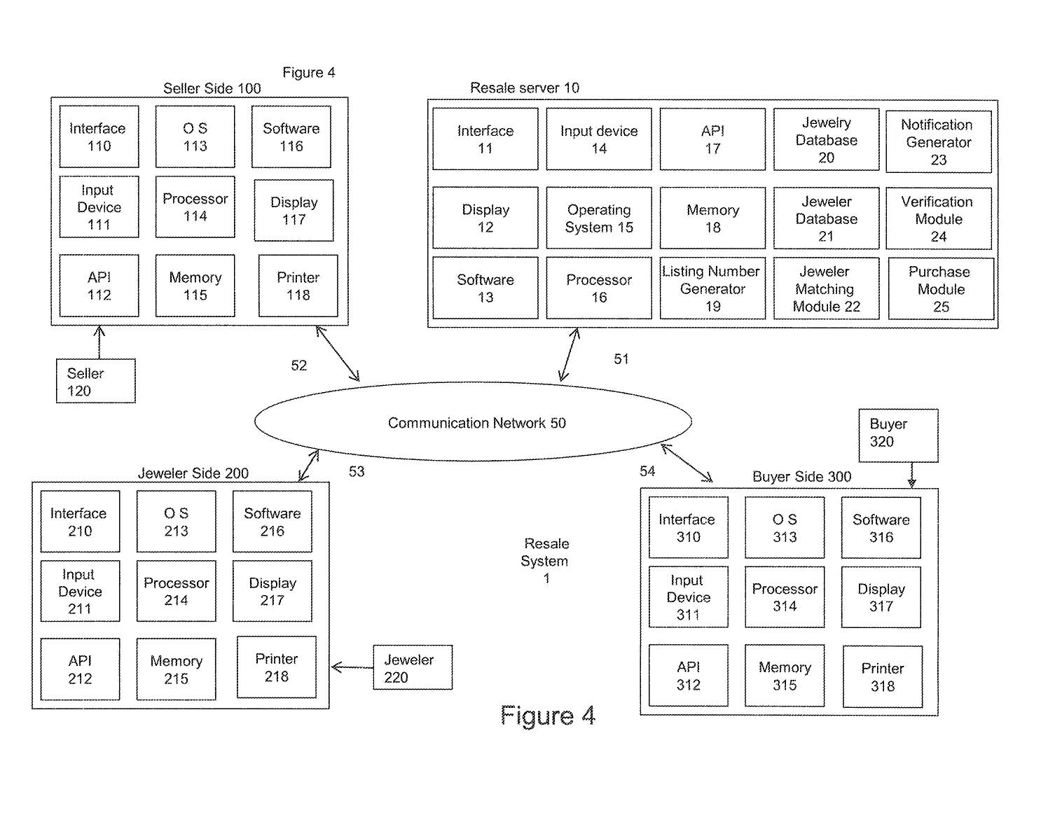

FIG. 4 is a schematic diagram of an example of a resale management system 1. The resale management system includes a resale management server 10, a seller side 100, a jeweler side 200, and a buyer side 300. For ease of explanation only one of each device is shown but more than one of each is contemplated.

The resale management server 10 includes an interface 11, a display 12, software, 13, input device 14, operating system 15, processor 16, application interface 17, memory, 18, listing number generator 19, jewelry database 20, entity database 21 jeweler matching module 22, notification generator, 23, verification module 24 and purchase module 25.

The seller side includes an interface 110, an input device 111, application interface 112, an operating system 113, a processor 114, a memory 115, software 116, a display 117 and a printer 118.

The jeweler side includes an interface 210, an input device 211, application interface 212, an operating system 213, a processor 214, a memory 215, software 216, a display 217 and a printer 218.

The buyer side includes an interface 310, an input device 311, application interface 312, an operating system 313, a processor 314, a memory 315, software 316, a display 317 and a printer 318.

The resale management system 10, the seller side 100, the jeweler side 200 and the buyer side 300 can be connected to one another over an interne: connection 50 but more secure connections are contemplated.

in some implementations, the system of FIG. 4 can be split into a computer-server environment communicatively connected over the internet 50 with connectors 51, 52, 53, 54 where the one or more servers 10 include hardware as shown in FIG. 4 and also code for generating listing numbers, code for generating notifications, code for matching locations to jewelers, code for verifying authenticity and code for allowing purchases.

The operating systems 15, 113, 213, 313 can be multi-user, multiprocessing, multitasking, multithreading, real-time and the like. The operating systems 15, 113, 213, 313 may perform basic tasks, including but not limited to: recognizing input from input devices 14, 111, 211, 311; sending output to display devices 12,117, 217, 317; keeping track of files and directories on computer-readable mediums 11, 20, 21, 115, 215, 315 (e.g., memory or a storage device); controlling peripheral devices (e.g., disk drives, printers, etc.) 118, 218, 318; and managing traffic on the one or more buses 51, 52, 53, 54.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be, or be included in, a computer-readable storage device, a computer-readable storage substrate, a random or serial access memory array or device, or a combination of one or more of them.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or combinations of them. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, e.g., a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user.

Embodiments of the subject matter described in this specification can be implemented in a computing system that includes a back-end component, e.g., as a data server, or that includes a middleware component, e.g., an application server, or that includes a front-end component, e.g., a buyer, seller, jeweler computer having a graphical user interface or a Web browser through which a user 120, 220, 320 can interact with an implementation of the subject matter described in this specification, or any combination of one or more such back-end, middleware, or front-end components. The components of the system can be interconnected by any forth or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include client sides 100, 200, 300 and servers 10. A client side 100, 200, 300 and server 10 are generally remote from each other and typically interact through a communication network 50. The relationship of client side and server arises by virtue of computer programs running on the respective computers and having a client side-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

The foregoing Detailed Description is to be understood as being in every respect illustrative and exemplary, but not restrictive, and the scope of the disclosed technology disclosed herein is not to be determined from the Detailed Description, but rather from the claims as interpreted according to the full breadth permitted by the patent laws. it is to be understood that the embodiments shown and described herein are only illustrative of the principles of the disclosed technology and that various modifications may be implemented by those skilled in the art without departing from the scope and spirit of the disclosed technology. Those skilled in the art could implement various other feature combinations without departing from the scope and spirit of the disclosed technology. Although the embodiments of the present disclosure have been described with specific examples, it is to he understood that the disclosure is not limited to those specific examples and that various other changes, combinations and modifications will be apparent to one of ordinary skill in the art without departing from the scope and spirit of the disclosed technology which is to be determined with reference to the following claims.

1. A resale management system useful in reselling jewelry items, the system comprising:
a computer server, which computer server is capable of being coupled to at least one seller computer and at least one jeweler computer and programmed to:
(i) receive a listing from the at least one seller computer, the listing including a description of a jewelry item, and the at least one seller computer being associated with a specific geographic location;
(ii) match at least one jeweler contained in an entity database to the specific geographic location, the entity database containing information on a plurality of jewelers;
(iii) send a first notification to the at least one seller computer and a second notification to the at least one jeweler computer defining a period of time for allowing the at least one jeweler to verify the jewelry item;
(iv) receive a verification signal from the at least one jeweler via the at least one jeweler computer verifying that the description of the jewelry item depicts the jewelry item; and
(v) offer the listing for sale on an on-line store associated with the computer server.

2. The resale management system of claim 1 wherein the computer server is further programmed to:
receive seller information; and
store the seller information in the entity database.

3. The resale management system of claim 1 wherein the computer server is further programmed to:
receive jeweler information from the plurality of jewelers; and
store the jeweler information in the entity database.

4. The resale management system of claim 1 wherein the listing from the at least one seller computer includes an asking price.

5. The resale management system of claim 4 wherein the verification signal further verifies that the asking price is fair and reasonable.

6. The resale management system of claim 1 wherein the jewelry item includes one of rings. bracelets, necklaces, watches, earring or loose stones.

7. The resale management system of claim 1 wherein the listing can be stored in a jewelry database under a listing number generated by the resale management system.

8. The resale management system of claim 1 wherein the specific geographic location can be one of: zip code, physical address, or GPS coordinates.

9. The resale management system of claim 8 wherein the computer server is further programmed to:
compare the specific geographic location to a location of the plurality of jewelers;
generate a listing of jewelers that are in close proximity to the specific geographic location: and
receive a request from the at least one seller computer choosing a specific jeweler from the list of jewelers.

10. The resale management system of claim 1 wherein the first notification further includes a listing number, the at least one jeweler's address, name of contact and phone number and a period of time to get the jewelry item to the at least one jeweler.

11. The resale management system of claim 1 wherein the second notification includes a listing number, listing details, seller's name and phone number, and a printer ready label containing the listing number and a brief description of the item.

12. The resale management system of claim 1 wherein the computer server is further programmed to:
receive buyer information; and
store the buyer information in the entity database.

13. The resale management system of claim 12 wherein the computer server is further programmed to:
allow a buyer to browse for desired jewelry item.

13. resale management system of claim 13 wherein the computer server is further programmed to;
allow a buyer to purchase the jewelry item in the on-line store.

15. The resale management system of claim 14 wherein the computer server is further programmed to
distribute payment to a seller with the at least one jeweler receiving a first percentage and an entity associated with the resale management system receiving a second percentage.

16. A computer-implemented method comprising the steps of:
(i) receiving a listing from the at least one seller computer, the listing including a description of a jewelry item, and the at least one seller computer being associated with a specific geographic location;
(ii) matching at least one jeweler contained in an entity database to the specific geographic location, the entity database containing information on a plurality of jewelers;
(iii) sending a first notification to the at least one seller computer and a second notification to the at least one jeweler computer defining a period of time for allowing the at least one jeweler to verify the jewelry item;
(iv) receiving a verification signal from the at least one jeweler via the at least one jeweler computer verifying that the description of the jewelry item depicts the jewelry item; and
(v) offering the listing for sale on an on-line store associated with the computer server.

17. The method of claim 10 wherein the listing can be stored in a jewelry database under a listing number generated by the resale management system.

18. The method of claim 16 further comprising the steps of:
comparing the specific geographic location to a location of the plurality of jewelers;
generating a listing of jewelers that are in close proximity to the specific geographic location; and
receiving a request from the at least one seller computer choosing a specific jeweler from the list of jewelers.

19. The method of claim 16 wherein the first notification further includes a listing number, the at least one jeweler's address, name of contact and phone number and a period of time to get the jewelry item to the at least one jeweler.

20. The method of claim 16 wherein the second notification includes a listing number, listing details, seller's name and phone number, and a printer ready label containing the listing number and a brief description of the item.
